(19) United States
(12) Patent Application Publication
(10) Pub. No.: US 2026/0290738 A1
(43) Pub. Date: Sep. 24, 2026

(54) VACUUM ENCLOSURES AND X-RAY SOURCES INCLUDING VACUUM ENCLOSURES WITH MULTIPLE SEALABLE OPENINGS

(71) Applicant: VAREX IMAGING CORPORATION, Salt Lake City, UT (US)

(72) Inventors: Ronald Wayne Boutte, Kaysville, UT (US); Bruce Allen Spencer, Grantsville, UT (US); Weston Jeffrey Wheeler, Farmington, UT (US)

(73) Assignee: VAREX IMAGING CORPORATION, Salt Lake City, UT (US)

(21) Appl. No.: 19/474,139

(22) PCT Filed: Sep. 25, 2024
(86) PCT No.: PCT/US2024/048373

§ 371 Date: Oct. 9, 2025

Related U.S. Application Data
(60) Provisional application No. 63/584,844, filed on Sep. 22, 2023.

(51) Int. Cl. H01J 35/16; H01J 35/20; H01J 35/26

(52) U.S. Cl. CPC H01J 35/16; H01J 35/20; H01J 35/26; H01J 2235/1204; H01J 2235/1291

(57) ABSTRACT

Embodiments include an apparatus, comprising: a vacuum enclosure including a housing including a first sealable opening and a second sealable opening separate from the first sealable opening; a first compressible seal disposed proximate to the first sealable opening and configured to form at least part of a vacuum seal over the first sealable opening when compressed; and a second seal sealing the second sealable opening.

### CROSS-REFERENCE TO RELATED APPLICATIONS

This application claims priority from and is a national stage application under 35 USC 371 of International Application No. PCT/US2024/048373, filed 25 Sep. 2024, which claims priority to U.S. Provisional Patent Application No. 63/584,844, filed 22 Sep. 2023, the entire disclosures of which are hereby incorporated by reference.

### BRIEF DESCRIPTION OF SEVERAL VIEWS OF THE DRAWINGS

FIG. 1 is a block diagram of a vacuum enclosure with a compressible seal according to some embodiments.

FIG. 2 is a block diagram of a sealable opening of the vacuum enclosure of FIG. 1 according to some embodiments.

FIG. 3 is a block diagram of a sealable opening of the vacuum enclosure of FIG. 1 with a screw according to some embodiments.

FIGS. 4A-4C are block diagrams of a sealable opening of the vacuum enclosure of FIG. 1 with a variety of counterbored holes according to some embodiments.

FIGS. 5A-5B are block diagrams of a sealable opening of the vacuum enclosure of FIG. 1 with alternate compression structures according to some embodiments.

FIG. 6 is a block diagram of an x-ray source according to some embodiments.

FIG. 7 is a block diagram of an x-ray imaging system according to some embodiments.

### DETAILED DESCRIPTION

Embodiments include vacuum enclosures and x-ray sources with vacuum enclosures with multiple sealable openings. The processing of a vacuum enclosure and, in particular a vacuum enclosure for an x-ray source may include purging the vacuum enclosure with a gas, such as nitrogen (N₂) or an inert gas, like argon (Ar). The gas may be used to pressurize the vacuum enclosure. The gas may cause other materials such as adsorbed materials, such as water (H₂O), to be removed from surfaces of the vacuum enclosure and enclosed components to be suspended within the gas. The gas may be evacuated to remove the materials.

Embodiments described herein may include a sealable opening separate from the opening through with the gas is supplied. Gas with the materials may escape through the sealable opening (or vent) to remove the materials. Embodiments described herein may also be applied to pressurized vessels rather than vacuum enclosures. However, vacuum enclosures will be used as an example.

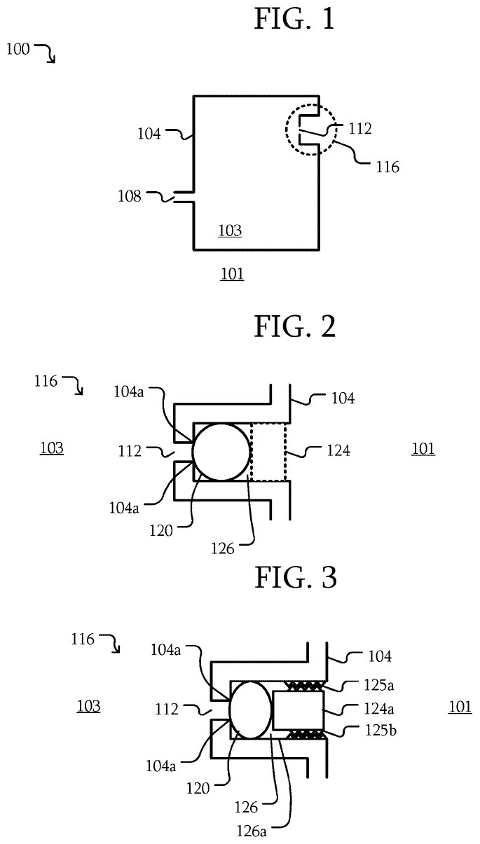

FIG. 1 is a block diagram of a vacuum enclosure with a compressible seal according to some embodiments. In some embodiments, the apparatus includes a vacuum enclosure 100 including a housing 104 including a first sealable opening 112 and a second sealable opening 108 opening separate from the first sealable opening 112. The vacuum enclosure 100 divides an interior 103 from an exterior 101. When the vacuum enclosure 100 is sealed, a vacuum may be formed within the interior 103. The housing 104 may include a vacuum compatible material or metal, such as stainless steel.

The apparatus may include any apparatus with a vacuum enclosure 100. For example, as will be described in further detail below, the vacuum enclosure 100 may be part of an x-ray source or x-ray tube.

Examples of the first sealable opening 112 include a cylindrical hole penetrating the housing 104. In other embodiments, the first sealable opening 112 may have different shapes such as a rectangular cross-section, an elliptical cross-section, or the like.

Examples of the second sealable opening 108 include a metal tube, such as copper tube, or the like.

FIG. 2 is a block diagram of a sealable opening of the vacuum enclosure of FIG. 1 according to some embodiments. Referring to FIGS. 1 and 2, in some embodiments, region 116 is a region including the first sealable opening 112.

A first compressible seal 120 disposed at least around the first sealable opening 112 and configured to form at least part of a vacuum seal over the first sealable opening 112 when compressed. The first compressible seal 120 may include a material that is compressible and vacuum compatible such as copper, stainless steel, oxygen-free high thermal conductivity (OFHC) material, oxygen-free electronic (OFE) copper, or the like. The first compressible seal 120 may include a material with a hardness, such as indentation hardness, that is less than that of the housing 104.

In some embodiments, the first compressible seal 120 may include a sphere. A sphere will be used as an example; however, the first compressible seal 120 may take other shapes such as a cylinder, a rectangular prism, ellipsoid, torus, washer, or the like. The first compressible seal 120 may be matched with the shape of the first sealable opening 112.

In a particular example, the first compressible seal 120 is a copper sphere matched to a cylindrical hole as the first sealable opening 112. A diameter of the copper sphere may be larger than the first sealable opening 112 by an amount such as 20%, 50%, or more.

As will be described in further detail below, a second seal may seal the second sealable opening 108. For example, the second seal may include a pinched copper tube.

In some embodiments the first compressible seal 120 is disposed over the entire first sealable opening 112 when compressed. The copper sphere described above is an example of a first compressible seal 120 that would cover the entire first sealable opening 112. However, in other embodiments, the first compressible seal 120 may include a torus, or washer. The torus or washer may be disposed around the first sealable opening 112. The compression structure 124 may include a structure that when used to compress the first compressible seal 120 also forms part of the complete vacuum seal over the first sealable opening 112. In contrast, in some embodiments, the first compressible seal 120 may form the complete vacuum seal over the first sealable opening 112 when compressed without relying on the compression structure 124. The compression structure 124 may include an area or shape that corresponds to the opening of recess 126, such as a cylinder or a rectangular prism.

In some embodiments, the compression structure 124 may be attached to the housing 104 in a variety of ways. In one example, the compression structure 124 may be welded to the housing 104 while the compression structure 124 is compressing the first compressible seal 120. In another example, the compression structure 124 may be peened to attach the compression structure 124 to the housing 104 while the compression structure 124 is compressing the first compressible seal 120.

In some embodiments, the housing 104 includes convex regions 104a. The convex regions 104a may allow the first compressible seal 120 to deform around the convex regions 104a, forming the vacuum seal.

When the vacuum seal is formed over the first sealable opening 112, the vacuum seal may have a leak rates that are as less than 1×10⁻¹¹ millibar-liters per second (mbar*L/sec) or 7.50×10⁻¹² Torr*L/sec (Torr liters per second).

In some embodiments, the first compressible seal 120 may be replaced by a first seal 120 that seals in a manner that does not involve compression.

In some embodiments, the first compressible seal 120 may include a tubular structure that may be sealed by compression of the tube. For example, a copper tube may be used as the first compressible seal 120 and sealed by compressing the walls of the copper tube.

In some embodiments, the compression structure 124 may be omitted. The first compressible seal 120 may be peened to both compress the first compressible seal 120 to for the vacuum seal over the first sealable opening 112 and attach the first compressible seal 120 to the housing 104.

FIG. 3 is a block diagram of a sealable opening of the vacuum enclosure of FIG. 1 with a screw according to some embodiments. In some embodiments, the components may be similar to that of FIG. 2. However, the compression structure 124 may include a screw 124a. The screw 124a is configured to compress the first compressible seal 120. In some embodiments, the screw 124a a may include a set screw without a head, while in other embodiments, the screw 124a may include a head. The screw 124a may be a sufficient length such that the head does not contact the housing 104 over a range of compression of the first compressible seal 120 sufficient to create the vacuum seal. As a result, the head of the screw 124a will not limit the compression of the compressible seal 120. A region of the housing 104 (e.g., within the recess 126) adjacent to the first sealable opening 112 includes threads 125a mated with threads 125b of the screw 124a. In some embodiments, the mating of the threads 125 may also form an additional part of the vacuum seal over the first sealable opening 112.

In some embodiments, the first sealable opening 112 is disposed within a recess 126 in an exterior wall of the housing 104. The recess 126 extends the wall of the housing 104 into the interior 103 of the vacuum enclosure 100. A metal sphere, when compressed, contacts a perimeter of the first sealable opening at the regions 104a and a sidewall 126a of the recess 126.

In some embodiments, the threads 125a on the housing 104 do not extend fully into the recess 126. The threads 125a may stop such that the first compressible seal 120 may deform on the sidewall 126a where there are no threads 125a. In some embodiments, the screw 124a extends past the end of the threads 125 in the recess 126. As a result, even if the first compressible seal 120 deforms around the screw 124a, it will not contact the threads 125a.

Although the tip of the screw 124a that contacts the first compressible seal 120 has been illustrated as being flat, in other embodiments, the shape may be different. For example, the shape may be a convex conical shape, a concave conical shape, a convex or concave spherical shape, or the like.

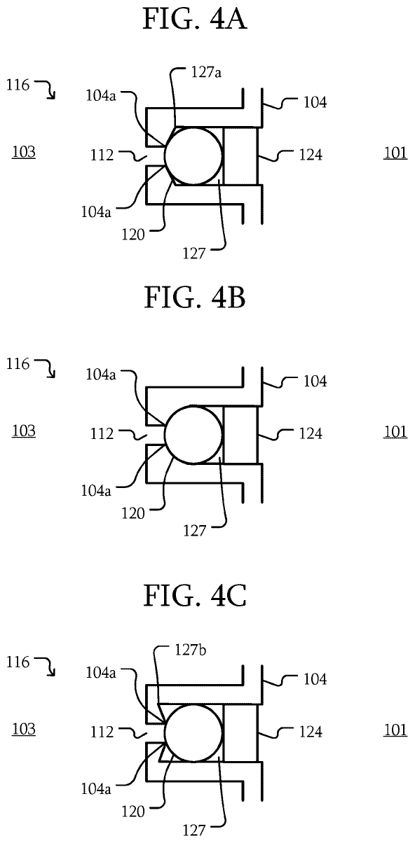

FIGS. 4A-4C are block diagrams of a sealable opening of the vacuum enclosure of FIG. 1 with a variety of counterbored holes according to some embodiments. In some embodiments, the housing 104 of the vacuum enclosure 100 includes a counterbored hole 127 as the recess 126. The first sealable opening 112 is disposed at a bottom of the counterbored hole 127.

The bottom of the counterbored hole 127 may include a variety of shapes. For example, the bottom of the counterbored hole 127 may include a flat surface as illustrated in FIG. 2, a curved surface as illustrated in FIG. 4B, a concave conical surface as illustrated in FIG. 4A; a convex conical surface as illustrated in FIG. 4C, or the like. Each of these shapes may still have the regions 104a around which the first compressible seal 120 may deform. In some embodiments, an angle 127a of the counterbored hole 127 may be about 118+/−10 degrees. An angle 127b of the counterbored hole 127 may be about 62+/−10 degrees.

Although particular angles or ranges of angles have been used as examples, in other embodiments, the angles may be different.

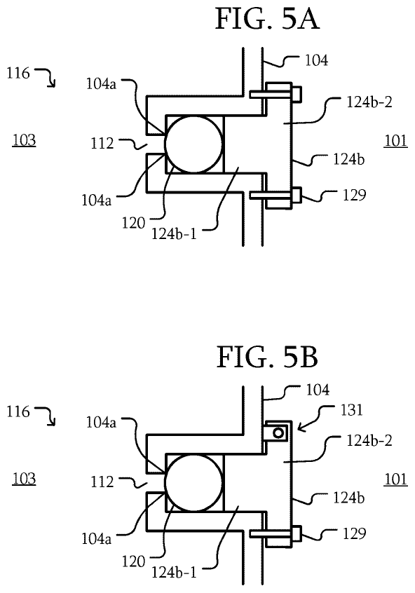

FIGS. 5A-5B are block diagrams of a sealable opening of the vacuum enclosure of FIG. 1 with alternate compression structures according to some embodiments. Referring to FIG. 5A, in some embodiments, the compression structure 124b may include a portion 124b-1 that contacts the first compressible seal 120. A second portion 124b-2 may be sufficiently far from the portion 124b-1 such that when the second portion 124b-2 is attached to the housing 104 with fasteners 129, the second portion 124b-2 does not make contact with the housing 104. Thus, the first compressible seal 120 may be compressed to create the vacuum seal with the requisite force before the second portion 124b-2 contacts the housing 104. The alternate compression structure of FIG. 5 may be used after the screw 124a as described with FIG. 3 or other compression structure 124 fails to maintain an adequate seal.

Referring to FIG. 5B, in some embodiments, the compression structure 124b may be similar to that of FIG. 5A. However, rather than having multiple fasteners 129, the compression structure 124b may be attached to the housing 104 at an anchor point 131. Examples of the anchor point 131 include a hinge, a bar attached to the housing 104 that mates with a corresponding channel of the compression structure 124b, a slot that mates with a corresponding tab of the compression structure 124b, or the like. A hinge is illustrated as the anchor point 131 as an example.

The anchor point 131 may allow the compression structure 124b to rotate about the anchor point 131. In some embodiments, the anchor point 131 is configured to resist rotation of the compression structure 124b when forces are applied to the compression structure 124b by the fastener 129 and the first compressible seal 120. That is, when the fastener 129 is tightened, the anchor point 131 causes at least some of the force to be applied to the first compressible seal 120.

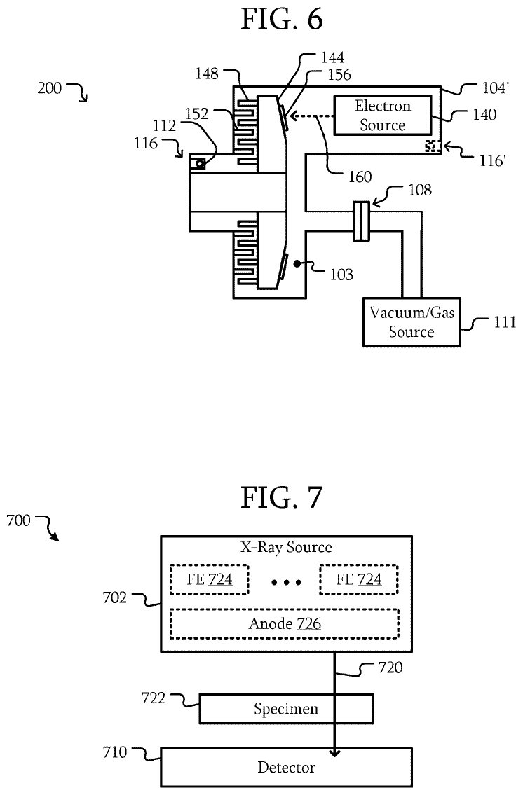

FIG. 6 is a block diagram of an x-ray source according to some embodiments. In some embodiments, an x-ray source 200 includes a vacuum enclosure 100 as described above. The x-ray source 200 may include an electron source 140 configured to generate an electron beam 160. A target 156 is disposed on an anode assembly within the vacuum enclosure and configured to generate radiation in response to the electron beam 160. Examples of the target 156 include material configured to generate x-rays in response to the electron beam 160 such as tungsten (W), molybdenum (Mo), rhodium (Rh), silver (Ag), rhenium (Re), palladium (Pd), or the like.

In some embodiments, the target 156 is disposed on a shortest gas path between the first sealable opening 112 and the second sealable opening 108. As a result, gas that enters the second sealable opening 108 is more likely to pass by the target 156 on the way out through the first sealable opening 112.

In some embodiments, the target 156 is disposed on a rotor assembly 144 (or bearing assembly or anode assembly). For conciseness, the rotor assembly or bearing assembly or anode assembly will be refer to herein as the rotor 144. The rotor 144 may be configured to rotate a bearing assembly during operation. The first sealable opening is disposed on a first side of the rotor 144 and the second sealable opening 108 is disposed on a second side of the rotor 144 that is opposite to the first side of the rotor 144. As a result, gas flowing from the second sealable opening 108 to the first sealable opening 112 may be more likely to pass over the rotor 144. Side as used herein refers to a plane form by major surface of the target area. The first side of the rotor 144 refers to a side facing towards the electron source 140 and the second side of the rotor 144 refers to a side facing away from the electron source 140 (towards a stator or heat sinks 148 and 152).

In some embodiments, the rotor 144 includes a first heat sink 148 on a side of the rotor 144 opposite to the target 156. The housing 104′ includes a second heat sink 152 meshed with the first heat sink 148. A gap may exist between the heat sinks 148 and 152 to allow the rotor 144 to move relative to the housing 104′. The gap may be relatively small to accommodate multiple fins of the heat sinks 148 and 152, increase the transfer of energy from the rotor 144 to the housing 104′, or the like. As a result, adsorbed materials on the heat sinks 148 and 152 may be difficult to remove merely by pressurizing the housing 104′ with a gas and evacuating the gas as used in conventional purging processes. However, if a shortest gas path between the first sealable opening 112 and the second sealable opening 108 includes space between the meshed portions of the first heat sink 148 and the second seat sink 152, the gas flowing along that path may be more likely to pass the surfaces with the adsorbed materials to remove the adsorbed materials from the housing 104′.

In some embodiments, multiple sealable opening similar to the first sealable opening 112 may be disposed on the housing 104′. For example, the housing 104′ of the vacuum enclosure of the x-ray source 200 includes a third sealable opening 116′ separate from the first sealable opening 112 and the second sealable opening 108. A third compressible seal (not numbered) disposed at least around the third sealable opening 116′ and configured to form at least part of a vacuum seal over the third sealable opening 116′ when compressed similar to the first compressible seal 120 described above.

Some embodiments include a method of evacuating a vacuum enclosure. The various vacuum enclosures 100 and x-ray sources 200 and the components will be used as examples. In some embodiments, a vacuum enclosure 100 including a housing 104 including a first sealable opening 112 and a second sealable opening 108 separate from the first sealable opening 112 is provided. A gas is passed through the vacuum enclosure 100 from the second sealable opening 108 to the first sealable opening 112 until a threshold condition occurs. For example, the vacuum/gas source 111 may be configured to supply gaseous nitrogen to the interior of the housing 104/104′.

The threshold condition may be a variety of conditions. For example, the threshold may be an amount of time. Thus, the gas may be supplied by the vacuum/gas source 111 for a predetermined amount of time that has been determined to be sufficient to remove a desired amount of materials from the vacuum enclosure 100 so that a desired level of vacuum such as a vacuum level on the order of 10⁻⁷ to 10⁻⁹ torr or the like. In another example, the threshold may include a character of the gas exiting the first sealable opening 112 that may indicate that a sufficient amount of material has been removed. The threshold condition may be any condition that indicates that a sufficient amount of material has been removed.

Once the condition occurs. The first compressible seal 120 may be compressed at the first sealable opening 112 to create a vacuum seal over the first sealable opening 112. The compression may occur according to the various compression structures 124 described above. In some embodiments, the sealing may be repeated for all sealable openings other than one that may be used to evacuate the housing 104/104′. In some embodiments, a cover is formed over the first compressible seal 120. For example, after a screw 124a or other compression structure 124 is used to compress, the first compressible seal 120, a cover, such as epoxy, a press-fit cap, or the like may be placed over the screw 124a or other compression structure 124.

The gas may be evacuated from the vacuum enclosure 100 by the vacuum/gas source 111. Once a desired level of vacuum is reached, the second sealable opening may be sealed to form a vacuum seal over the second sealable opening 108 after evacuating the gas from the vacuum enclosure 100. For example, the second sealable opening 108 may be an opening in a copper tube. The copper tube may be compressed or pinched off such that a vacuum compatible seal is formed across the opening in the copper tube.

In some embodiments, as described above, a screw 124a may be used to compress the first compressible seal 120. For example, while the gas is escaping through the first sealable opening 112, a copper sphere may be placed over the first sealable opening 112. A set screw 124a may be inserted into the threaded recess 126. In other embodiments, the copper sphere and the set screw 124a may be installed before gas is supplied, but still allow gas to escape through the first sealable opening 112. The set screw 124a may be tightened until a desired level of compression is reached for the desired quality of a vacuum seal while the gas is escaping. Sealing the first sealable opening 112 with a copper sphere is an example of compressing the first compressible seal 120 over the entire first sealable opening 112. As part of compressing the copper sphere, the copper sphere may be compressed into the sidewalls 126a of the recess 126.

The first compressible seal 120 may have advantages over a tubulated seal, such as the pinched off or compressed copper tube used to seal the second sealable opening 108. For example, the first compressible seal 120 may be reusable, where the seal can be unsealed and resealed. The first compressible seal 120 may be more durable than the tubulated seal when a force is applied to the seal, where the tubulated seal may be damaged, open up, and leak with the force. The first compressible seal 120 may be safer to handle as the first compressible seal 120 may not have sharp edges like the tubulated seal that can cut or scratch an operator or user.

As described above, the vacuum enclosure 100 or x-ray source 200 may include multiple sealable openings. The gas may be passed through each of these from the second sealable opening 108. Each of these may be sealed as described above with respect to the first sealable opening 112.

In some embodiments, the vacuum enclosure 100 includes an electron source 140 and a rotor 144. Passing the gas through the vacuum enclosure 100 from the second sealable opening 108 to the first sealable opening 112 comprises passing the gas between the rotor 144 and the housing 104′ on a path between the second sealable opening 108 to the first sealable opening 112. As described above, this path may include space between heat sinks 148 and 152.

Some embodiments include means for enclosing a vacuum such as the housings 104/104′. Some embodiments include means for generating x-rays disposed within the means for enclosing a vacuum such as the electron source 140 and the target 156. Some embodiments include first means for penetrating the means for enclosing the vacuum such as the first sealable opening 112 or the third sealable opening 116′. Some embodiments include second means for penetrating the means for enclosing the vacuum such as the second sealable opening 108. Some embodiments include first compressible means for sealing the first means for penetrating the means for enclosing the vacuum such as the first compressible seal 120. Some embodiments include second means for sealing the second means for penetrating the means for enclosing the vacuum such as the seal of a copper tube. Some embodiments include means for compressing the first compressible means such as the screw 124a.

FIG. 7 is a block diagram of an x-ray imaging system according to some embodiments. The x-ray imaging system 700 includes an x-ray source 702 and detector 710. The x-ray source 702 may include x-ray source 200 or the like as described above. In some embodiments, the x-ray source 702 includes multiple field emitters (FE) 724. Electron beams from the field emitters 724 may be directed towards an anode 726 to generate x-rays 720. The x-ray source 702 is disposed relative to the detector 710 such that x-rays 720 may be generated to pass through a specimen 722 and detected by the detector 710. In some embodiments, the detector 710 is part of a medical imaging system. In other embodiments, the x-ray imaging system 700 may include a portable vehicle scanning system as part of a cargo scanning system. The system 700 may be any system that may include an x-ray source 702.

Some embodiments include an apparatus, comprising: a vacuum enclosure 100 including a housing 104, 104′ including a first sealable opening 112 and a second sealable opening 108 separate from the first sealable opening 112; a first compressible seal 120 disposed proximate to the first sealable opening 112 and configured to form at least part of a vacuum seal over the first sealable opening 112 when compressed; and a second seal sealing the second sealable opening 108.

In some embodiments, the first compressible seal 120 is disposed over the entire first sealable opening 112 when compressed.

In some embodiments, the apparatus further comprises a screw 124a compressing the first compressible seal 120; wherein a region of the housing 104, 104′ adjacent to the first sealable opening 112 includes threads mated with threads of the screw 124a.

In some embodiments, the housing 104, 104′ of the vacuum enclosure 100 includes a counterbored hole; and the first sealable opening 112 is disposed at a bottom of the counterbored hole.

In some embodiments, the bottom of the counterbored hole includes: a flat surface; a curved surface; a concave conical surface; or a convex conical surface.

In some embodiments, the first compressible seal 120 was a metal sphere before compression.

In some embodiments, the first sealable opening 112 is disposed within a recess in an exterior wall of the housing 104, 104′; and the metal sphere, when compressed, contacts a perimeter of the first sealable opening 112 and a sidewall of the recess.

In some embodiments, the housing 104, 104′ of the vacuum enclosure 100 includes a third sealable opening 116′ separate from the first sealable opening 112 and the second sealable opening 108; and the apparatus further comprises a third compressible seal 120 disposed at least around the third sealable opening 116′ and configured to form at least part of a vacuum seal over the third sealable opening 116′ when compressed.

In some embodiments, the apparatus further comprises a compression structure 124, 124b configured to compress the first compressible seal 120; and a fastener 129 configured to apply a force to the compression structure 124, 124b to cause the compression structure 124, 124b to compress the first compressible seal 120.

In some embodiments, the apparatus further comprises an anchor point 131 attached to the housing 104, 104′ and coupling the compression structure to the housing 104, 104′.

In some embodiments, the apparatus further comprises an electron source 140 disposed within the vacuum enclosure 100 and configured to generate an electron beam 160; and a target 156 disposed within the vacuum enclosure 100 and configured to generate radiation in response to the electron beam 160, wherein the apparatus is a radiation tube or x-ray source.

In some embodiments, the target 156 is disposed on a shortest gas path between the first sealable opening 112 and the second sealable opening 108.

In some embodiments, the target 156 is disposed on a rotor assembly 144; the first sealable opening 112 is on a first side of the target; and the second sealable opening 108 is on a second side of the target that is opposite to the first side of the target 156.

In some embodiments, the target 156 is disposed on a rotor assembly 144; the rotor assembly 144 includes a first heat sink 148 on a side of the rotor assembly opposite to the target; the housing 104, 104′ includes a second heat sink 152 meshed with the first heat sink 148; and a shortest gas path between the first sealable opening 112 and the second sealable opening 108 includes space between the meshed portions of the first heat sink 148 and the second seat sink 152.

Some embodiments include a method, comprising: providing a vacuum enclosure 100 including a housing 104, 104′ including a first sealable opening 112 and a second sealable opening 108 separate from the first sealable opening 112; passing a gas through the vacuum enclosure 100 from the second sealable opening 108 to the first sealable opening 112 until a threshold condition occurs; compressing a first compressible seal 120 at the first sealable opening 112 to create a vacuum seal over the first sealable opening 112.

In some embodiments, the method further comprises evacuating the gas from the vacuum enclosure 100; and sealing the second sealable opening 108 to form a vacuum seal over the second sealable opening 108 after evacuating the gas from the vacuum enclosure 100.

In some embodiments, compressing the first compressible seal 120 at the first sealable opening 112 comprises compressing the first compressible seal 120 with a screw 124a.

In some embodiments, compressing the first compressible seal 120 at the first sealable opening 112 comprises compressing the first compressible seal 120 over the entire first sealable opening 112.

In some embodiments, compressing the first compressible seal 120 at the first sealable opening 112 comprises compressing a metal sphere on to the first sealable opening 112.

In some embodiments, compressing the first compressible seal 120 at the first sealable opening 112 comprises compressing the metal sphere into sidewalls of a recess in the housing 104, 104′ including the first sealable opening 112.

In some embodiments, the housing 104, 104′ of the vacuum enclosure 100 includes a third sealable opening 116′ separate from the first sealable opening 112 and the second sealable opening 108; and the method further comprises: passing the gas through the vacuum enclosure 100 from the second sealable opening 108 to the third sealable opening 116′ until the threshold condition occurs; and compressing a third compressible seal 120 at the third sealable opening 116′ to create a vacuum seal over the third sealable opening 116′.

In some embodiments, the vacuum enclosure 100 includes an electron source and a rotor; and passing the gas through the vacuum enclosure 100 from the second sealable opening 108 to the first sealable opening 112 comprises passing the gas between the rotor 144 and the housing 104, 104′ on a path between the second sealable opening 108 to the first sealable opening 112.

Some embodiments include an x-ray device, comprising: means for enclosing a vacuum; means for generating x-rays disposed within the means for enclosing a vacuum; first means for penetrating the means for enclosing the vacuum; second means for penetrating the means for enclosing the vacuum; and first compressible means for sealing the first means for penetrating the means for enclosing the vacuum; and second means for sealing the second means for penetrating the means for enclosing the vacuum.

In some embodiments, the x-ray device further comprises means for compressing the first compressible means.

Some embodiments include an apparatus, comprising: a vacuum enclosure 100 including a housing 104, 104′ including a first sealable opening 112 and a second sealable opening 108 separate from the first sealable opening 112; a first seal disposed at least around the first sealable opening 112 and configured to form at least part of a vacuum seal over the first sealable opening 112 when sealed; and a second seal sealing the second sealable opening 108.

Although the structures, devices, methods, and systems have been described in accordance with particular embodiments, one of ordinary skill in the art will readily recognize that many variations to the particular embodiments are possible, and any variations should therefore be considered to be within the spirit and scope disclosed herein. Accordingly, many modifications may be made by one of ordinary skill in the art without departing from the spirit and scope of the appended claims.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description. These additional embodiments are determined by replacing the dependency of a given dependent claim with the phrase “any of the claims beginning with claim [x] and ending with the claim that immediately precedes this one,” where the bracketed term “[x]” is replaced with the number of the most recently recited independent claim. For example, for the first claim set that begins with independent claim 1, claim 4 can depend from either of claims 1 and 3, with these separate dependencies yielding two distinct embodiments; claim 5 can depend from any one of claims 1, 3, or 4, with these separate dependencies yielding three distinct embodiments; claim 6 can depend from any one of claims 1, 3, 4, or 5, with these separate dependencies yielding four distinct embodiments; and so on.

Recitation in the claims of the term “first” with respect to a feature or element does not necessarily imply the existence of a second or additional such feature or element. Elements specifically recited in means-plus-function format, if any, are intended to be construed to cover the corresponding structure, material, or acts described herein and equivalents thereof in accordance with 35 U.S.C. § 112(f). Embodiments of the invention in which an exclusive property or privilege is claimed are defined as follows.

1. An apparatus comprising:
a vacuum enclosure including a housing including a first sealable opening and a second sealable opening separate from the first sealable opening;
a first compressible seal disposed proximate to the first sealable opening and configured to form at least part of a vacuum seal over the first sealable opening when compressed; and
a second seal sealing the second sealable opening.

2. The apparatus of claim 1, wherein:
the first compressible seal is disposed over the entire first sealable opening when compressed.

3. The apparatus of claim 1, further comprising:
a screw compressing the first compressible seal;
wherein a region of the housing adjacent to the first sealable opening includes threads mated with threads of the screw.

4. The apparatus of claim 1, wherein:
the housing of the vacuum enclosure includes a counterbored hole; and
the first sealable opening is disposed at a bottom of the counterbored hole.

5. (canceled)

6. (canceled)

7. The apparatus of claim 1, wherein:
the first sealable opening is disposed within a recess in an exterior wall of the housing; and
the first compressible seal is configured to contact a perimeter of the first sealable opening and a sidewall of the recess when compressed.

8. The apparatus of claim 1, wherein:
the housing of the vacuum enclosure includes a third sealable opening separate from the first sealable opening and the second sealable opening; and
the apparatus further comprises a third compressible seal disposed at least around the third sealable opening and configured to form at least part of a vacuum seal over the third sealable opening when compressed.

9. The apparatus of claim 1, further comprising:
a compression structure configured to compress the first compressible seal; and
a fastener configured to apply a force to the compression structure to cause the compression structure to compress the first compressible seal.

10. The apparatus of claim 9, further comprising:
an anchor point attached to the housing and coupling the compression structure to the housing.

11. The apparatus of claim 1, further comprising:
an electron source disposed within the vacuum enclosure and configured to generate an electron beam; and
a target disposed within the vacuum enclosure and configured to generate radiation in response to the electron beam, wherein the apparatus is a radiation tube or an x-ray source.

12. The apparatus of claim 11, wherein:
the target is disposed on a shortest gas path between the first sealable opening and the second sealable opening.

13. The apparatus of claim 11, wherein:
the target is disposed on a rotor assembly;
the first sealable opening is on a first side of the target; and
the second sealable opening is on a second side of the target that is opposite to the first side of the target.

14. The apparatus of claim 11, wherein:
the target is disposed on a rotor assembly;
the rotor assembly includes a first heat sink on a side of the rotor assembly opposite to the target;
the housing includes a second heat sink meshed with the first heat sink; and
a shortest gas path between the first sealable opening and the second sealable opening includes space between meshed portions of the first heat sink and the second seat sink.

15. A method comprising:
providing a vacuum enclosure including a housing including a first sealable opening and a second sealable opening separate from the first sealable opening;
passing a gas through the vacuum enclosure from the second sealable opening to the first sealable opening until a threshold condition occurs;
compressing a first compressible seal at the first sealable opening to create a vacuum seal over the first sealable opening.

16. The method of claim 15, further comprising:
evacuating the gas from the vacuum enclosure; and
sealing the second sealable opening to form a vacuum seal over the second sealable opening after evacuating the gas from the vacuum enclosure.

17. (canceled)

18. (canceled)

19. The method of claim 15, wherein:
compressing the first compressible seal at the first sealable opening comprises compressing a metal sphere on to the first sealable opening.

20. The method of claim 19, wherein:
compressing the first compressible seal at the first sealable opening comprises compressing the metal sphere into sidewalls of a recess in the housing including the first sealable opening.

21. The method of claim 15, wherein:
the housing of the vacuum enclosure includes a third sealable opening separate from the first sealable opening and the second sealable opening; and
the method further comprises:
passing the gas through the vacuum enclosure from the second sealable opening to the third sealable opening until the threshold condition occurs; and
compressing a third compressible seal at the third sealable opening to create a vacuum seal over the third sealable opening.

22. The method of claim 15, wherein:
the vacuum enclosure includes an electron source and a rotor; and
passing the gas through the vacuum enclosure from the second sealable opening to the first sealable opening comprises passing the gas between the rotor and the housing on a path between the second sealable opening to the first sealable opening.

23. An x-ray device comprising:
a vacuum enclosure,
a target for generating x-rays disposed within the vacuum enclosure;
a recess in the vacuum enclosure;
a first opening penetrating the vacuum enclosure through the recess;
a second opening penetrating the vacuum enclosure; and
a first metal compressible seal in the recess for sealing the first opening; and
a second seal for sealing the second opening.

24. The x-ray device of claim 23, further comprising:
a screw for compressing the first metal compressible seal.

25. (canceled)
